(19) United States
(12) Patent Application Publication
(10) Pub. No.: US 2003/0082290 A1
(43) Pub. Date: May 1, 2003

(54) Method for stabilizing bran and the resultant composition

(76) Inventor: Bob J. Dull, O'Fallon, IL (US)

Correspondence Address: POLSINELLI SHALTON & WELTE, P.C., 700 W. 47TH STREET, SUITE 1000, KANSAS CITY, MO, 64112-1802, US

(21) Appl. No.: 10/002,969

(22) Filed: Nov. 1, 2001

(51) Int. Cl. A23L 1/20

(52) U.S. Cl. 426/626

(57) ABSTRACT

The present invention relates to a method for stabilizing and treating bran, wherein the method includes adding an amount of base to hydrated bran so as to saponify the fatty acids. The present invention also relates to a treated bran product having a caloric fat value equal to untreated bran with the nascent proteins intact, and containing salts of fatty acids.

### FIELD OF INVENTION

The present invention relates to a method for stabilizing bran using the process of saponification.

### BACKGROUND OF INVENTION

When harvested from a field, rice, oats, barley, and wheat, are enveloped by a hull. To make suitable for human consumption, each particular type of grain must be milled. After being dried, the grain is milled to remove the hull, yielding, for example, brown rice. In a second stage of milling, the outer brown layer is removed from the rice kernel to yield polished or white rice. As such, bran is the fibrous residue remaining from the milling process. Depending on the milling techniques, the bran may include part of the germ or endosperm, and it may also be mixed with part of the hull.

Brans from different types of grains are of similar compositions. For example, the composition of rice bran (in percent by weight) ranges between about 11% and about 13% of water, between about 18% and about 21% of crude fat and oil, between about 14% and about 16% crude protein, between about 8% and about 10% of crude fiber, between about 9% and about 12% of ash, and between about 33% and about 36% of carbohydrate. Regardless from which grain the bran is derived, it is inherently unstable. The presence of trigylcerides, which contain fatty acids, along with the presence of lipase enzymes, cause the resulting bran instability. These unsaturated fatty acids contained in the triglycerides are easily oxidized. The process of milling the bran from endosperm facilitates the intimate contact of the bran oils, with active lipase enzymes. As the bran oil comes into contact with the active lipase enzymes, the processes of enzymatically facilitated oxidization begins. This process is extremely rapid, and produces free fatty acids, which can then be further attacked by oxygen radicals, hydroxyl radicals, or other oxidative enzyme systems. The enzymatically facilitated oxidization of the bran results in the production of off-flavors, including a rancid smell and taste, and nutritive degradation, which leads to the bran becoming unpalatable for humans, as well as livestock.

Under normal milling conditions (ambient temperatures above freezing), the bran will degrade into an unpalatable material, which is not suitable as a human food. Such degradation will typically take between six (6) hours and two (2) days. Because of the problems associated with rancidity, most bran is used as feed for animals. Beyond three (3) days, the bran is largely unpalatable to livestock, as well.

To circumvent rancidity problems, the oil from bran is sometimes extracted for use as human food. Because of the lipases, most extractions are carried out close to the growing areas in small capacity mills. Thus, the extraction method is designed to remove the fats (substrate) from the bran. This is an undesired approach because some of the nutritional value is stripped from the bran, and lubricity of the bran decreases. Lubricity is desirable for uses in finished products.

To obviate this problem, it has been known that naturally occurring lipases can be deactivated by heating the bran for a short period of time. For example, by passing the bran through an extruder, such as a high temperature, high-pressure extruder, the lipases are deactivated. The use of heat is undesirable because it degrades the nutritional value. Specifically, the heat stabilizes the bran; however, in the process, protein is denatured, and other sensitive nutrients are destroyed by the heat so that the bran has a lower nutritional value.

Other methods have been described, which rely on the use of protease enzymes to destroy active lipase and lipoxygenase. The addition of proteases can increase the cost and may make handling more difficult. Similarly, enzyme activity can be eliminated through the addition of acid to the isoelectric point of the enzymes resulting in enzyme inactivation.

A final alternative process is the removal of the lipase substrate from the bran. Inactivation of the lipase substrate from the bran utilizing antibodies, or means to control or remove co-factors, is important for enzyme activity. However, this process has not been fully developed.

Saponification is a known process. It is not, however, typically used to produce products ultimately intended for human consumption.

What is desired is a method for stabilizing bran in order to keep the bran, and the oil from the bran, from becoming rancid. It is further preferred to have a system, which will not denature the proteins found in the bran or reduce the nutritional quality. Additionally, a method should be practiced which will convert already available free fatty acids that have occurred because of lipase activity, into stable salts, which do not have an odor of their own, and do not react to lipoxygenase or other enzymes. Finally, it is desired to have a bran product in which the proteins are not denatured, and the oil is stabilized. The product may be further treated with protease or other enzymes.

### SUMMARY OF INVENTION

The present invention relates to a method for stabilizing a wide range of different types of bran, including oat, barley, rice, corn, or wheat bran, and the resultant stabilized bran. The method includes saponification of the fats found in the bran product, followed by the optional addition of acid to neutralize the base.

Saponification requires the addition of a base, preferably either ammonia, sodium hydroxide, or potassium hydroxide, in order to raise the pH of the bran mixture to an alkaline pH suitable to effect saponification. The pH will range between 7.5 and 14, and more preferably between about 8.5 to about 11. The bran should be contacted with the base for a time period sufficient to saponify all the available fats present in the bran. This typically takes between about 0.1 minutes and about 90 minutes, with the amount of time dependent upon the temperature and the strength of the base. In order to speed the reaction rate, the bran should be heated prior to, or during, the addition of the base. The temperature of the bran can range between 40° F. and 211° F., more preferably it will range between about 75° F. and 140° F. The base will saponify the fats. Upon completion of saponification, the pH may be reduced to from between about 6.5 to about 8.0 by the addition of an acid. The resultant pH is dependent upon the final use, which means the pH can vary outside the recited range. Any food grade acid may be used, including food grade hydrochloric, phosphoric, or acetic acid.

The conversion of the triglycerides in the bran to salts of fatty acids, greatly reduces and typically virtually eliminates the potential for oxidative rancidity through charred stabilization of the acyl moiety. The subsequent reduction or elimination of free fatty acids from the bran, provides for the bran's stability by removing the substrates which the enzymes, such as lipase, attack. This treatment further converts already available free fatty acids that occur as a result of lipase activity, to stable salts, which do not have an odor of their own, and do not react to lipoxygenase or other enzymes.

The resultant bran has the nascent proteins intact and a caloric fat value equal to untreated bran. Importantly, the bran contains salts of fatty acids. The resultant bran can be used for any of a variety of end products.

The present invention is advantageous because a method is provided that does not change the nutritional characteristic of bran. Further, the method provides for a stabilized bran that does not turn rancid. The present invention is also advantageous because it is inexpensive and comparatively easy to perform.

### DETAILED DESCRIPTION

The present invention relates to a method for stabilizing bran, including oat, barley, rice, corn, or wheat bran, whereby the fatty acids are made unavailable for oxidation. The present invention also relates to the resultant stabilized bran and products made from the stabilized bran. Stabilizing the bran means preventing the bran from becoming rancid. In particular, the present invention relates to eliminating a substrate, which can be oxidized to produce a rancid bran product. The process does not rely on defatting the bran. Rather, it renders the fat stabilized through the use of the process of saponification.

The method of the present invention is initiated by obtaining an amount of bran. As stated above, any type of grain-based bran material may be used, including rice bran, oat bran, barley bran, corn bran, or wheat bran. Any amount of bran may be treated according to the present method. The only practical limitation is the size of the vessel in which the bran is treated. Resultingly, an amount of bran ranging between 1 pound and 10,000 pounds can typically be treated. Note that the present process can be a batch, continuous, or continuous batch process, dependent upon the particular equipment available.

An amount of water is added to the bran sufficient to hydrate the bran. The water can be distilled or tap water. Preferably, a soup-like mixture is formed, whereby the bran is covered with water. Essentially, the bran is fully hydrated. The preferred ratio is 1:5 mix of 1 part by weight bran to 5 parts by weight water. During the hydration process, the water and bran mixture is preferably heated to a temperature ranging between 40° F. and 211° F., more preferably 120° F. and 140° F. Any of a variety of temperatures may be used, as long as the reaction rate is increased and no adverse reactions occur. In particular, it is important that the material not be heated to the point where it is cooked, or a maillard reaction occurs. It is desired to heat the bran material sufficiently so that the reaction speed is increased, but the flavor, taste, or nutritional value of the resultant product is not impacted by the heat.

Saponification requires the addition of an amount of base, preferably sodium hydroxide (NaOH) or potassium hydroxide (KOH); however, other bases may be used. Any base that raises the initial pH of the bran mixture to between about 7.5 and about 14, more preferably 8.5 and 11, can be used. Preferably, an initial pH of approximately 10 is achieved. The amount of base added is dependent upon the amount of bran being treated; however, it must be sufficient to achieve the desired pH. Also, the molar concentration of the base will impact how much is added. This bran mixture is heated prior to, or during, the addition of the base. Again, the temperature of the water and bran mixture will range between about 40° F. and 211° F. during the time of the reaction with the base. More preferably, the temperature will range between 120° F. and 140° F. The reaction time is from between about 0.1 minutes to about 90 minutes, preferably 30 minutes. Contact between the base and the bran should be sufficient to convert the fatty acids, found in the bran, to salts of the fatty acids. Thus, the reaction will convert the fatty acids, typically triglycerides, to salts of fatty acids and glycerol.

The saponification reaction is illustrated as follows:

(C₁₇H₃₅COO)₃C₃H₅+3NaOH→3C₁₇H₃₅COONa+C₃H₅(OH)₃

Next, the pH of the bran mixture is optionally reduced to between about 6.5 to about 8.0, preferably to approximately 7.0 by the addition of acid. Preferably food grade acid, such as hydrochloric acid (HCl), phosphoric (H₃PO₄), or acetic acid (CH₃ COOH) is used. Other food grade acids can be used, as long as the pH is sufficiently lowered. The acid is added to bring the mixture back to neutral. While the present step is preferred, it is not required. The pH of the treated bran is only dependent upon the final use of the bran.

This reduction, or elimination of free fatty acids from the bran provides for its stability by removing the substrates, which the lipase and lipoxygenase enzymes attack. A further advantage of this treatment, is that it converts already available free fatty acids that occur as a result of previous lipase activity, into stable salts which do not have an odor of their own and do not react on their own with the lipoxygenase or other enzymes.

After the addition of the acid, the bran product may be pasteurized in order to further destroy all microbial activity. Pasteurization is not required, but it is preferred.

Alternatively, after processing, proteases, xylanases, or other enzymes may be added to the bran.

The bran material is optionally dehydrated, or dried, to achieve a total moisture content of about 7%. The amount of moisture remaining in the bran is somewhat dependent upon the final use of the product, and whether preservatives are added, or other steps will be taken, in order to preserve the quality of the bran. The wet stabilized bran can be dried by air drying, oven drying, vacuum drying, freeze drying, or any drying process which will produce a dried product. The dried product has a moisture content, which preferably will range between about 6% to about 10% by weight, and can be stored for long periods of time without deterioration. Dried, stabilized bran product can be rewetted for further processing, or used as an ingredient in various food or food products.

The resultant bran can be used in beverages, supplements, doughs, and any product requiring improved nutritional quality. The resultant bran maintains the same caloric content as untreated bran, with the nascent proteins still intact. Nearly all of the available fatty acids are converted to salts of fatty acids. There will be lipase activity in the bran, but no available substrate. As such, the caloric content of the bran remains unchanged. Also, bran which is rancid or has an increased number of fatty acids, can be saponified to restore its palatability.

### EXAMPLES

### Example 1

Fresh rice bran equal to 100 pounds was suspended in water of elevated temperature (140° F. preferred), at a ratio of 1:5 bran (wt)/water (wt). A pH approximating 10 was achieved by adding an amount of sodium hydroxide. The pH was measured using a pH meter manufactured by Fisher Scientific. After a 30 minute period, food grade acid (HCl), was added to reduce the pH to about 7.0. The below table shows the amount of fatty acids found in treated and untreated bran.

| | | | Control Bran Treated | |
|---|---|---|---|---|
| Time | Control | Base Treated Bran | with Base at 72 Hours | |
| 0 hr | 0.55 | 0.46 | 0.61 | |
| 12 hr | 9.77 | 0.51 | 10.3 | |
| 24 hr | 14.4 | 0.44 | 15.1 | |
| 72 hr | 29.0 | 0.6 | 28.8 | 0.50* |
| 96 hr | 44.5 | 0.53 | | 0.55** |

How measured:
Free fatty acids in milliequivalents (meg) present in control bran and base treated bran.
*Values of control bran before and after treatment with base
**Value of treated control bran at 96 hours post milling and 24 hours after treatment with base

The fatty acids were determined using AOAC procedure 940.28.

The treatment stabilized the bran by eliminating the substrate for lipase, and by converting all fatty acids, free or in glycerol acyl esters, to salts of fatty acids, thus eliminating the potential for rancidity. As can be seen from the above table, the present method maintains the level of free fatty acids. When the control product was treated, which had increased levels of free fatty acids, the fatty acids were decreased to levels similar to those in products treated initially.

Thus, there has been shown and described a method for stabilizing bran, which fulfills all the objects and advantages sought therefore. It is apparent to those skilled in the art, however, that many changes, variations, modifications, and other uses and applications for stabilizing bran are possible, and also such changes, variations, modifications, and other uses and applications which do not depart from the spirit and scope of the invention are deemed to be covered by the invention, which is limited only by the claims which follow.

What is claimed is:

1. A method for stabilizing bran comprising:
(a) adding an amount of bran to an amount of water to form a hydrated bran composition;
(b) heating said bran composition to between about 40° F. and 211° F.;
(c) adding an amount of base to said bran composition in an amount sufficient to have an initial pH ranging between about 7.5 and about 14.0, with said base contacting said bran composition for between about 0.1 minutes and about 90 minutes to thereby saponify fats in said bran; and,
(d) separating the remaining water from said bran.

2. The method for stabilizing bran of claim 1, comprising adding an amount of acid to said bran composition in an amount sufficient to have a pH of between about 5.0 and about 8.0.

3. The method for stabilizing bran of claim 1 comprising drying said bran composition.

4. The method for stabilizing bran of claim 1, wherein said base is added to the bran until the bran/base mixture has a pH of about 10.0 for about 30 minutes.

5. The method for stabilizing bran of claim 2, wherein said acid is added to the bran/base mixture until the pH reaches 6.5.

6. The method for stabilizing bran of claim 1, wherein the bran is derived from the group consisting of oat, barley, wheat, rice, corn, and combinations thereof.

7. The method for stabilizing bran of claim 1, wherein said bran to water ratio is 1:5 by weight.

8. A method of stabilizing bran which comprises converting fatty acids found in bran to salts of fatty acids comprising adding an amount of base to hydrated bran to achieve a resultant pH of between about 7.5 and 14.0, with such pH sufficient to saponify the fatty acids.

9. The method of stabilizing bran of claim 8 comprising adding an acid to said bran containing said saponified triglycerides to thereby lower the pH to between about 5.0 and about 8.0.

10. The method of stabilizing bran of claim 8, wherein the bran is selected from the group consisting of oat, barley, wheat, rice, corn, and combinations thereof.

11. A method of making palatable rancid bran comprising converting fatty acids found in bran to salts of fatty acids comprising adding an amount of base to hydrated bran to achieve a resultant pH of between about 7.5 and 14.0, with such pH sufficient to saponify the fatty acids.

12. A method for stabilizing bran comprising:
(a) adding an amount of bran to an amount of water to form a hydrated bran composition;
(b) heating said bran composition to between about 40° F. and 211° F.;
(c) adding an amount of base to said bran composition in an amount sufficient to have a pH ranging between about 7.5 and about 14.0, with said base contacting said bran composition for between about 0.1 minutes and about 90 minutes;
(d) adding an amount of acid to said bran composition in an amount sufficient to have a pH of between about 5.0 and about 8.0; and,
(e) separating the remaining water from said bran, by drying said bran composition.

13. The method of claim 12, wherein said bran is heated at a temperature ranging between 120° F. and 140° F., at a pH ranging between 8.5 and 11.0

14. A bran composition comprising an amount of treated bran having a caloric fat value equal to untreated bran, nascent proteins of said bran intact, and salts of fatty acids.
